(19) United States
(12) Patent Application Publication
(10) Pub. No.: US 2001/0034634 A1
(43) Pub. Date: Oct. 25, 2001

(54) Customer information collection method and system

(75) Inventor: Hiroshi Ueda, Tokyo (JP)

Correspondence Address: KODA & ANDROLIA, 2029 Century Park East. Suite 3850, Los Angeles, CA, 90067-3024, US

(73) Assignee: GAIAX CO., LTD.

(21) Appl. No.: 09/754,624

(22) Filed: Jan. 4, 2001

(30) Foreign Application Priority Data
Apr. 21, 2000 (JP) 2000-121152

(51) Int. Cl. G06F 17/60

(52) U.S. Cl. 705/10

(57) ABSTRACT

In a customer information collection method and system which collects and analyzes large quantities of reliable customer information in a secure and efficient manner and at a low cost, a recording medium on which added information is recorded is attached to a product, and the added information recorded on the recording medium is not disclosed unless the purchaser of the product inputs information concerning the purchaser as data and transmits this data to a predetermined location via an electrical communications circuit.

### BACKGROUND OF THE INVENTION

1. Field of the Invention

The present invention relates to a customer information collection method and system.

2. Prior Art

For corporation that supply products to the marketplace, customer information, and especially customer information concerning products that have already been supplied to the marketplace (e.g., impressions following use of the product, desires for subsequent products, etc.) is important. Also, information from customers who have already purchased products is in itself of commercial value.

Conventionally, questionnaires are used as a means of collecting customer information concerning the products. Methods used to distribute such questionnaires can be divided into two main categories: methods that use the mail and methods that use electrical communications means.

Methods that use the mail include postcards attached to the products themselves, and direct mail which is distributed regardless of whether the product is purchased or not. For example, in cases where the product is a book, customer information can be collected by the customer who purchases and reads the book filling out and returning an attached postcard. Such customer information includes information concerning the customer himself, e.g., name, age, gender, address, occupation, etc., and information from the customer concerning the product, e.g., impression after reading, desires regarding future works, etc. Valuable suggestions for the marketing of subsequent products of the same type can be obtained by way of collecting, compiling and analyzing such customer information from numerous customers.

Methods that use electrical communications means include questionnaires that are distributed via telephone, fax, the Internet, etc. In such methods, the collected information can be compiled and analyzed more efficiently than in the case of postcards, etc., especially if the questionnaires are distributed via the Internet; and the collected information can be formed into a database.

However, the above conventional customer information collection methods have some problems.

First of all, in both methods that utilize the mail and methods that utilize electrical communications means, it is very difficult to accomplish the collection of customer information in a reliable manner. The return of postcards through the mail is bothersome to begin with. Conventionally, furthermore, an incentive for returning such postcards has sometimes been created by means of an arrangement in which a premium is won if the postcard is returned. Nevertheless, such postcards are sent without a response in many cases, and the postcard recovery rate remains low even when such a system is used. This is also true in cases where the Internet is used.

Secondly, especially in the case of methods that utilize the mail, the compilation of the collected customer information tends to be inefficient. In order to achieve the effective utilization of information in the marketing of subsequent products of the same type, large quantities of customer information must be compiled in a short time without a great expenditure of effort. Otherwise, the value of the information itself will be lost. In many cases, furthermore, marketing efforts are directed by comparing customer information compiled for respective products with similar information obtained for other products. In this sense, there is an especially great need to construct a database of such customer information so that analysis methods that may arise in the future can be handled.

Third, especially in the case of methods that utilize the mail, the quantity of information that can be collected from respective customers tends to insufficient. Ordinarily, such methods are arranged so that predetermined questions are entered in the limited space on the back surface of a postcard, and responses to these questions are obtained. Accordingly, it is physically difficult for the number of questions to reach several tens of questions. Furthermore, assuming that the number of questions is large, it may be envisioned that the customer will be put off by this and eventually will not send the postcard back.

Fourth, especially in the case of methods that utilize the mail, the cost of collecting customer information tends to be high. The postage for the postcards is ordinarily paid by the collector of information as a cost of collecting customer information. However, in addition to the fact that the postcard recovery rate is poor (as described above), there are limits to the amount of information that can be obtained from recovered postcards. Thus, the information per unit collected is expensive.

Fifth, in both methods that utilize the mail and methods that utilize electrical communications means, when questionnaires are distributed independently of the purchase of products, the trouble of distributing the questionnaires separately from the product by postcard, e-mail, etc., arises. Furthermore, since the time that the questionnaire is sent is not always linked with the time or purchase or use of the product, in other words since the questionnaire may be sent after a long time has elapsed following the use of the product, there may be problems in terms of the reliability or accuracy of the information.

Meanwhile, with the recent spread of the Internet, numerous so-called “on-line communities”, which are virtual communities, have been created. Various conveniences such as the acquisition of information, on-line shopping, on-line reservations, etc. are obtained by becoming a member of such an on-line community. The manager who recruits members into such an on-line community and manages the community generally distributes so-called “banner advertisement” of corporations to the on-line community and receives an advertising fee from these corporations as compensation. Such advertising fees are the main source of income for such managers. Accordingly, for such managers, it is important to give corporations an incentive for distributing advertising to the on-line community. For this reason, the individualization of on-line communities into children- or women-oriented communities, or communities centered on occupations or interests (rather than simple general communities), has progressed. By utilizing such individualized on-line communities, corporations can target specified customers according to the product involved and advertise more efficiently.

In such cases, in order to make the communities attractive to corporations for advertising purposes, it is important to increase the membership of individualized on-line communities, thus expanding the scale of such on-line communities. The key question here is how to provide customers with an incentive to join such communities.

### SUMMARY OF THE INVENTION

In light of the above-described problems, the present invention provides a customer information collection method which makes it possible to collect and analyze large quantities of reliable customer information in a secure and efficient manner and at a low cost.

Another object of the present invention is to provide a customer information collection method which promotes subscription to an on-line community formed by an electrical communications circuit.

In the customer information collection method of the present invention, a recording medium on which an added information is recorded is attached to a product, and such an added information recorded on the recording medium is not provided to the purchaser of the product unless the purchaser inputs information concerning the purchaser as data and transmits this data to a predetermined location via an electrical communications circuit.

The information concerning the purchaser may include information concerning permission for the purchaser to participate in an on-line community formed by an electrical communications circuit.

It is desirable that the information concerning the purchaser include at least the name, age, gender and e-mail address of the purchaser.

It is also desirable that the information data concerning the purchaser that is transmitted via the electrical communications circuit be processed and that a database be constructed and controlled.

The added information be auditory information or visual information.

The added information may include graphics images and/or still images.

Furthermore, the above-described product may be a book, and the live voice of the author of the book may be included as information in the added information.

Furthermore, the product may be a medium on which music is recorded, and additional music other than the primary music contained in the product may be contained as the added information.

In addition, the product may be a medium on which a program for playing a game is recorded, and a program for playing another game other than such a primary game may be contained as the added information.

Furthermore, the product may be a medium on which a program for playing a game is recorded, and information concerning this game may be included in the added information.

Moreover, the above-described “predetermined location” may be specified by an e-mail address. This way, the information data concerning the purchaser is processed into e-mail, and the e-mail resulting from this processing is transmitted to the specified e-mail address.

Furthermore, a password may be taught when the information data concerning the purchaser is transmitted. In this case, the added information recorded on the recording medium may be supplied only when the password is inputted.

Furthermore, once the information data concerning the purchaser is transmitted, the added information recorded on the recording medium may be supplied even if the purchaser of the product fails to input the information concerning the purchaser as data.

Moreover, it can be established that the above-described customer information may consist of one or more predetermined items. In this case, the type and scope of the data that is inputted for each of such items may be set in advance; and in cases where data that does not fit the type or scope of the inputted data is inputted, it is not judged that the customer information data has been inputted.

Furthermore, the above-described problems are solved by the customer information collection system of the present invention in which, so as to collect and process customer information, data is transmitted and received between one or more customer information input processing devices and a customer information processing device that are connected via an electrical communications; and

the customer information input processing devices are respectively comprise:

a data read-in means which reads in and sends added information data concerning a product, which is recorded on a medium attached to such a product,

an input means which converts the inputted customer information into customer information data and sends this data, a data processing means which processes the customer information data supplied from the input means and transmits this data to the customer information processing device via the electrical communications circuit, and which reads the added information data into the data read-in means and processes the supplied added information data when the customer information data is inputted, and

an information display means which displays the added information based upon said added information data;

the above-described customer information processing device comprises:

a receiving means which receives the customer information data that is transmitted via the electrical communications circuit,

an accumulating means which accumulates the customer information data,

a database control means which constructs a database based on the customer information data, processes the customer information data so that the data is accumulated in the accumulating means, and controls the resulting database, and

a data tabulating and analyzing means which tabulates and analyzes the customer information data that is controlled by the database control means.

In the customer information collection method and system according to the present invention, added information is caused to act as an incentive to customers so that customer information is provided subjectively from the customers, thus making it possible for corporations to collect customer information reliably in exchange for added information.

Furthermore, by collecting customer information via an electrical circuit through a recording medium that is attached to the product, it is possible to collect large quantities of information in a timely manner in accordance with the time of purchase and time of use of the product. It is further possible to analyze such collected customer information efficiently by constructing a database, etc. from such information.

Meantime, the recording medium, for instance, a CD (compact disk), used in the present invention shows a drop in unit cost as the quantity produced increases, and this recording medium is extremely compact, thin and light-weight. Accordingly, the recording medium can be attached to a product, e.g., a book, merely by inserting the recording medium into the book, so that almost no additional expenditure is required on the product itself. Thus, customer information concerning the product can be collected at a low cost. Furthermore, especially in cases where the “product” to be sold is a recording medium such as game software, music, etc., it is only necessary to record the added information on the product itself.

### BRIEF DESCRIPTION OF THE DRAWINGS

FIG. 1 is a block diagram which illustrates the customer information collection system according to one embodiment of the present invention;

FIG. 2 is a flow chart of the processing operation on the side of the customer information input processing device in the customer information collection system shown in FIG. 1;

FIG. 3 illustrates an example of information input screen used to input customer information in the customer information collection system shown in FIG. 1;

FIG. 4 illustrates an example of another information input screen used to input customer information in the customer information collection system shown in FIG. 1;

FIG. 5 shows an information input screen that continues to the screen shown in Figure 4; and

FIG. 6 shows an added information output screen in the customer information collection system shown in FIG. 1.

### DETAILED DESCRIPTION OF THE PREFERRED EMBODIMENTS

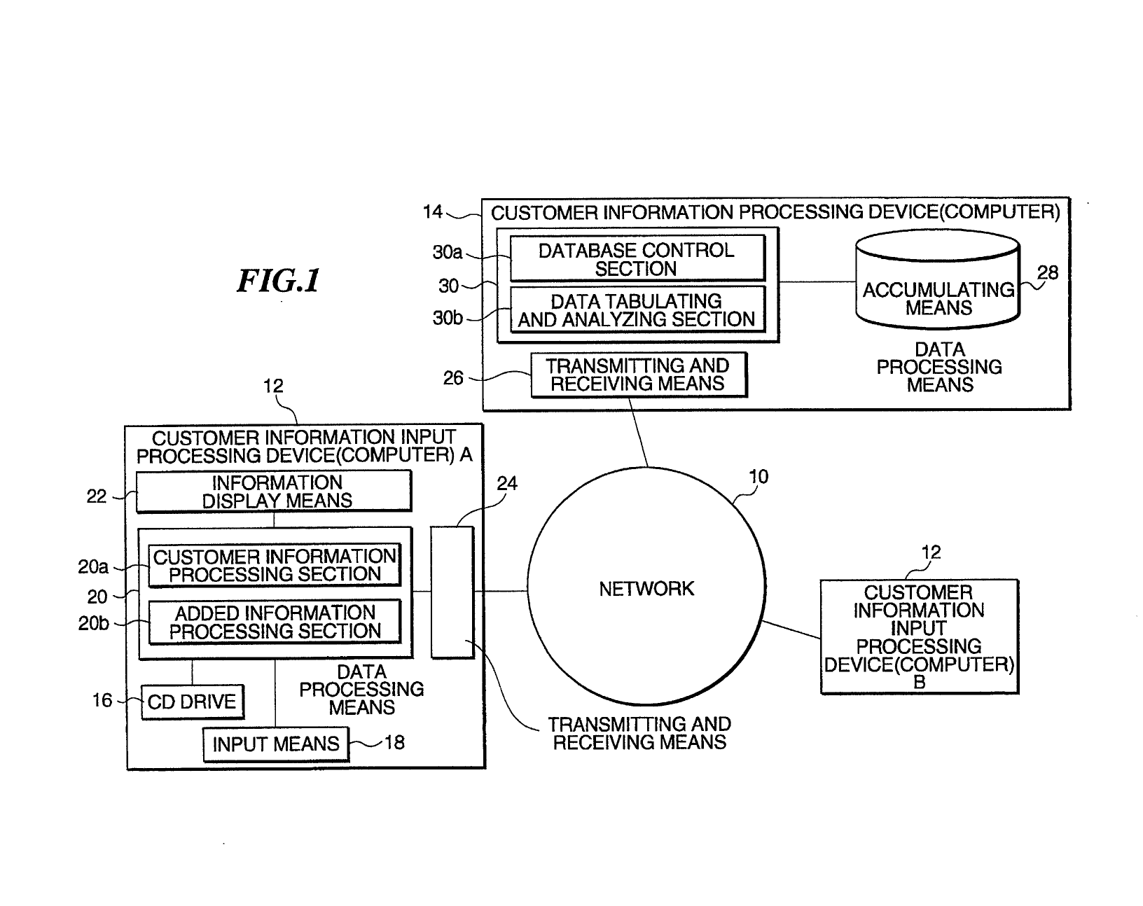

Embodiments of the present invention will be described in detail below with reference to FIGS. 1 through 6, using a case as an example in which the product is a book, and the recording medium attached to the product is a CD-ROM.

In FIG. 1, the system is arranged so that the transmission and reception of data are performed between one or more customer information input processing devices 12 (two such devices, i.e., A and B in this embodiment) and a customer information processing device 14. The customer information input processing devices 12 and the customer information processing device 14 are connected via a network 10 so that customer information is collected and processed. The customer information input processing devices 12 is an intelligent communications terminals, e.g., personal computers; and each of such devices 12 comprises a data read-in means 16, an input means 18, a data processing means 20, an information display means 22 and a transmitting and receiving means 24.

The data read-in means 16 is, for instance, a CD drive; and it is arranged so that the data read-in means 16 reads in added information data concerning the product that is recorded on a medium attached to the product and sends this data to the data processing means 20.

The input means 18 is, for instance, a keyboard; and it is arranged so that the input means 18 converts the input customer information into customer information data and sends this data to the data processing means 20.

The data processing means 20 comprises a customer information processing sections 20a and an added information processing section 20b. The customer information processing section 20a processes the customer information data supplied from the input means 18, and sends the processed data to the transmitting and receiving means 24 which then send the data to the customer information processing device 14 via the network 10. Meanwhile, the added information processing section 20b is arranged so that it reads added information data into the data read-in means 16 when customer information data is inputted, and so that it processes the supplied added information data.

The information display means 22 is, for instance, a display; the information display means 22 is arranged so that it provides added information on the basis of the added information data.

The transmitting and receiving means 24 is arranged so as to transmit data from the customer information input processing device 12 and receive data by the customer information input processing device 12 via the network 10.

Meanwhile, the customer information processing device 14 comprises a transmitting and receiving means 26, an accumulating means 28 that accumulates customer information data, and a data processing means 30.

The transmitting and receiving means 26 receives customer information data that is transmitted via the network 10 from the customer information input processing device 12. The data processing means 30 comprises a database control means 30a and a data tabulating and analyzing means 30b. The database control means 30a constructs a database on the basis of the customer information data, processes this customer information data, causes this data to be accumulated in the accumulating means 28, and controls this data. Meanwhile, the data tabulating and analyzing means 30b is arranged so that it tabulates and analyzes the customer information data controlled by the database control means 30a.

The operation of the customer information collection system described above will be described below.

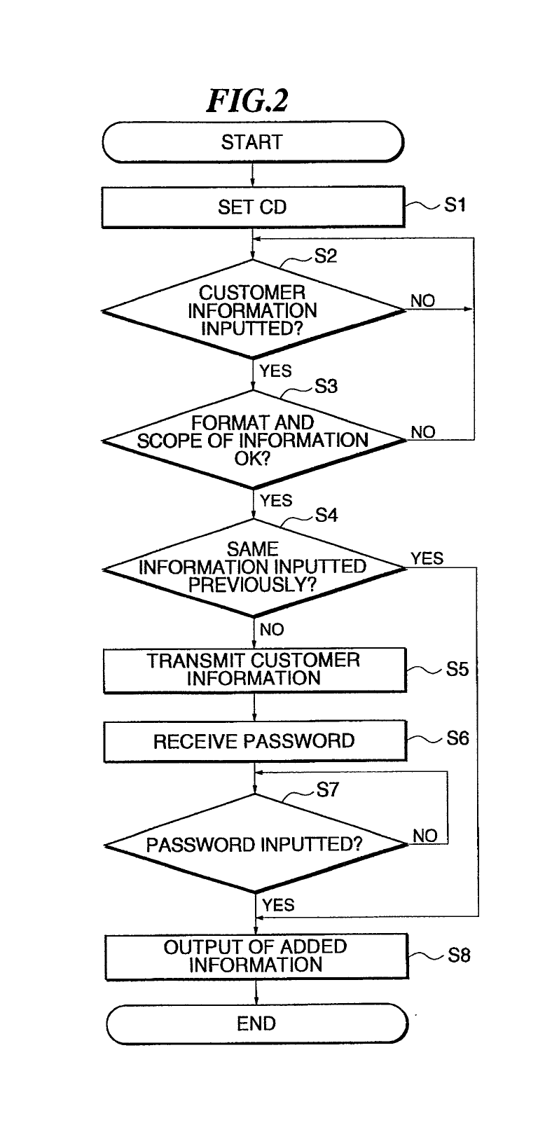

First, as shown in FIG. 2, a customer who has purchased a book sets the accompanying CD-ROM that constitutes the recording medium in the CD drive 16 (step S1). In this case, it is desirable that a simple introduction, e.g., “The author himself will introduce the location that forms the background of this novel to you!” or “The author himself will introduce an episode leading to the completion of this novel!” be noted on the CD-ROM or book in order to prompt the customer to set the CD-ROM in the drive.

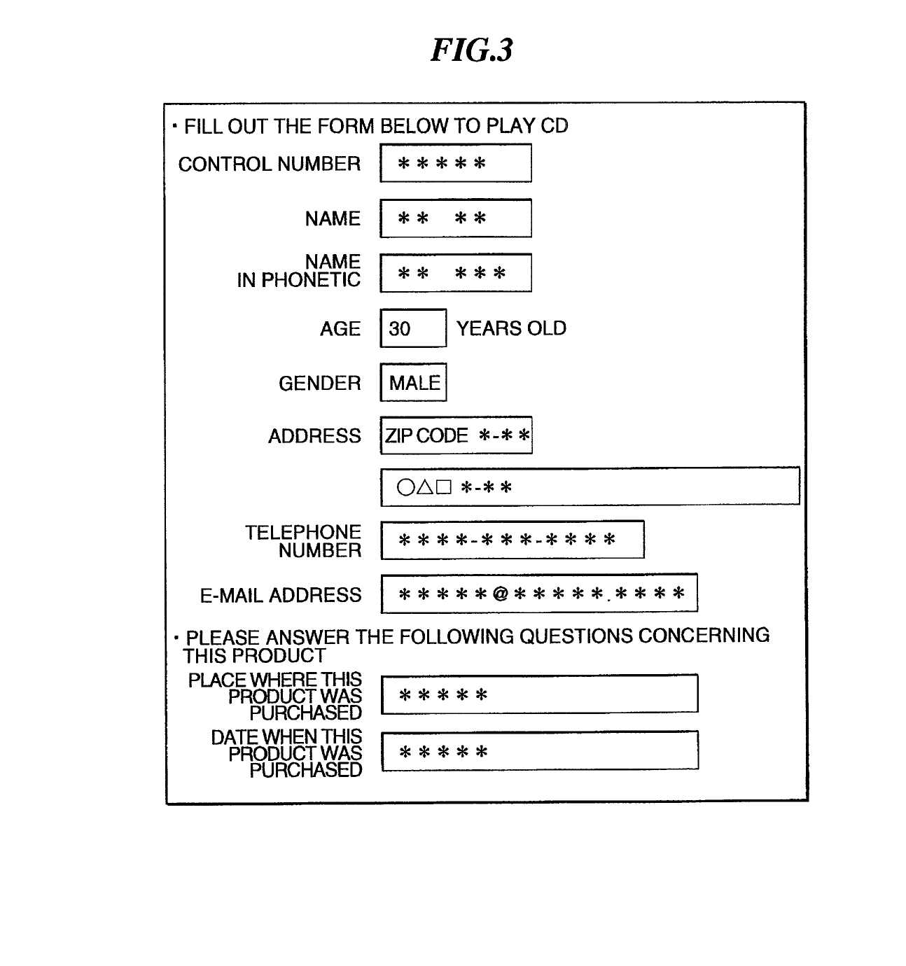

Next, in step S2, a judgement is made as to whether or not customer information has been inputted. If such information has been inputted, the processing proceeds to step S3 so that added information on the CD-ROM will be provided in exchange for the input of customer information. Examples of the input screens for the customer information that is to be inputted are shown in FIGS. 3 through 5. If, on the other hand, such information has not been inputted, the processing returns to the initial step S1.

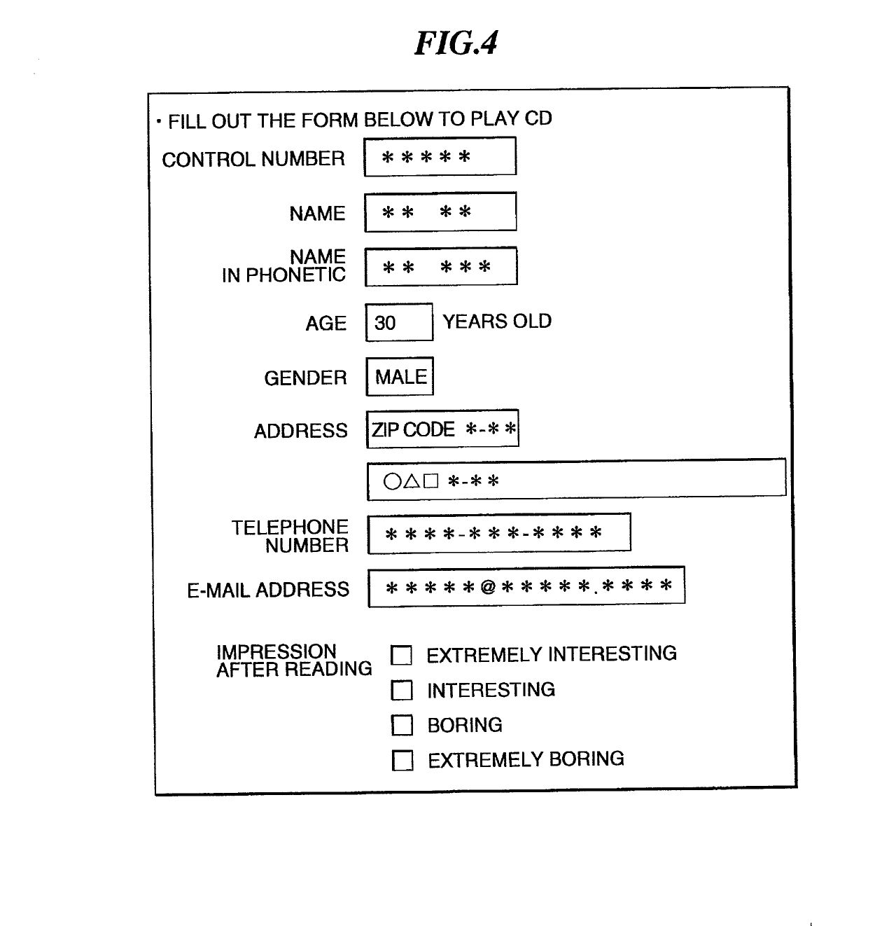

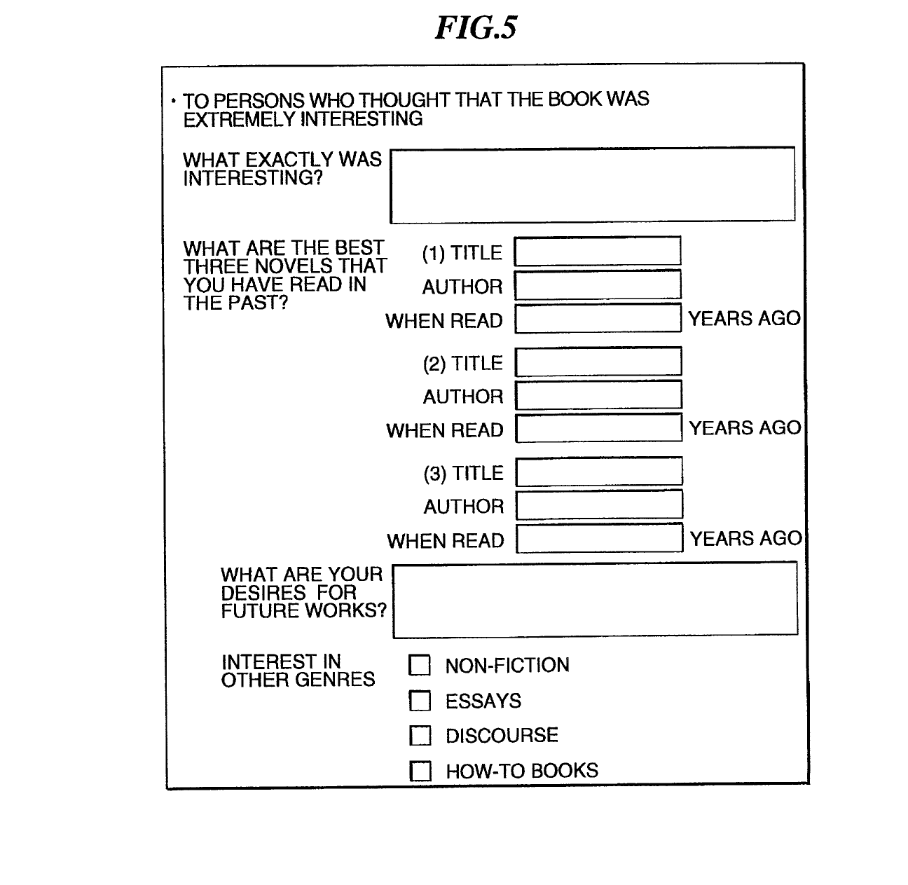

As shown in FIG. 3, customer information is divided into two main categories: information concerning the customer himself, and information from the customer concerning the product. Information concerning the customer himself includes the name, age, address, occupation and e-mail address of the customer, while information from the customer concerning the product includes the date and location of purchase of the product. If the product is a book, as shown in FIG. 4, such information includes the thoughts of the customer after reading the book. In this case, the construction of a database is facilitated by making the items to be inputted of the customer information hierarchical as shown in FIGS. 4 and 5. In other words, the system is arranged so that the thoughts following reading are hierarchically classified, and then the customer can switch to the next associated questions by clicking on the corresponding location. FIG. 5 shows the next questions in a case where the customer clicked on “extremely interesting” in FIG. 4.

Next, in step S3, a judgement is made as to whether or not the format and scope of the input customer information are appropriate. If these items are appropriate, the processing proceeds to step S4; if not, the processing returns to step S1. In this way, appropriate customer information can be collected in exchange for the added information.

Next, in step S4, a judgement is made as to whether or not the customer information has been inputted in the past. If this information has not been inputted in the past, the processing proceeds to step S5; on the other hand, if the information has been inputted in the past, the processing skips to step S8, and the added information is immediately outputted In this way, the collection of duplicate customer information is prevented.

Next, in step S5, the inputted customer information is transmitted to the customer information processing device 14. In the customer information processing device 14 receiving this information, a database based on the customer information data is constructed by the database control means 30a, and the customer information data is processed and accumulated in the accumulating means 28. Furthermore, the customer information data controlled by the database control means 30a is tabulated and analyzed by the data tabulating and analyzing means 30b.

Next, in step S6, a password is transmitted to the customer information input processing device 12 by the customer information processing device 14, and this password is received by the transmitting and receiving means 24.

In step S7, a judgement is made as to whether or not a password has been inputted. If a password has been inputted, the processing proceeds to step S8; if a password has not been inputted, the processing returns to step S6.

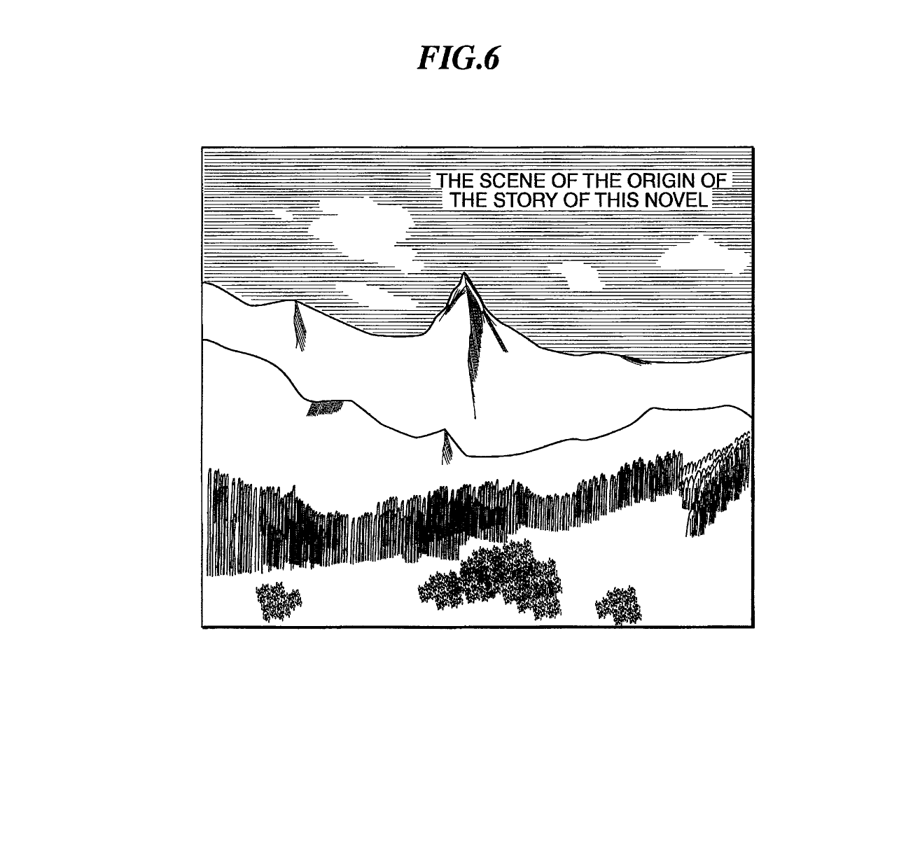

Next, in step S8, the added information is outputted. As shown in FIG. 6, the added information consists, for instance, of auditory and visual movie information. Actual scenery at the location forming the background where the novel was created, and the behind-the-scenes story leading to the writing of the novel in the author's own voice, for instance, are provided.

As seen from the above, the added information acts as an incentive to the customer; and the customer sets the CD-ROM in the drive in order to obtain the added information, but the added information recorded on the CD-ROM cannot be obtained unless there is an exchange for customer information. Thus, the system is operated so that the customer himself provides customer information in a subjective manner.

Especially in cases where an on-line community is managed by the information collection side, a request for permission to participate in the on-line community can be included in the customer information. This way, the customer is urged to join the on-line community in exchange for the provision of added information. Meanwhile, from the standpoint of corporations providing products, advertising that targets specified customer strata in accordance with the products involved can be accomplished by means of banner advertisement in the on-line community or by means of direct advertisement to the home addresses of customers acquired as customer information. Accordingly, efficient advertising can be accomplished.

Embodiments of the present invention is described above in detail. However, various alterations and modifications are possible within the scope of the present invention. In the above embodiment, the product involved is a book. However, the present invention is not limited to such a product; and any product may be promoted as long as it is possible to attach a recording medium such as a CD, etc. to the product at the time of marketing. In this case, the term “attach” does not refer only to cases in which the recording medium is physically attached to the product. It is rather used in a broad sense including cases in which the recording medium is obtained together with the product at the time of purchase. For example, in cases where the product is a CD of game software, the added information includes free game software or background information, etc. In cases where the product is a music CD, the added information includes music which is other than the primary music and written by the same composer, songwriter, etc. In such cases, since the product itself is a CD, the added information can be recorded on the product itself.

As described above in detail, the customer information collection system and method of the present invention collect and analyze large quantities of reliable customer information in a secure and efficient manner and at a low cost.

Furthermore, membership in on-line communities formed by networks can also be promoted.

What is claimed is:

1. A customer information collection method characterized in that: a recording medium on which added information is recorded is attached to a product, and said added information recorded on said recording medium is kept undisclosed until a purchaser of said product inputs information concerning said purchaser as data and transmits said data to a predetermined location via an electrical communications circuit.

2. The customer information collection method according to claim 1, wherein said information concerning said purchaser includes a request for a permission for said purchaser to participate in an on-line community formed via an electrical communications circuit.

3. The customer information collection method according to claim 1, wherein said information concerning said purchaser includes at least name, age, gender and e-mail address of said purchaser.

4. The customer information collection method according to claim 1, wherein said information data concerning said purchaser that is transmitted via said electrical communications circuit is processed, and a database of said information data is constructed and controlled.

5. The customer information collection method according to claim 1, wherein said added information is auditory information or visual information.

6. The customer information collection method according to claim 1, wherein said added information includes graphic images or still images.

7. The customer information collection method according to claim 1, wherein said product is a document, and a live voice of an author of said document is included as information in said added information.

8. The customer information collection method according to claim 1, wherein said product is a medium on which music is recorded, and music other than said music contained in said product is contained as information in said added information.

9. The customer information collection method according to claim 1, wherein said product is a medium on which a program for playing a game is recorded, and a program for playing a game other than said game is contained as information in said added information.

10. The customer information collection method according to claim 1, wherein said product is a medium on which a program for playing a game is recorded, and information concerning said game is included in said added information.

11. The customer information collection method according to claim 1, wherein said predetermined location is specified by an e-mail address, said information data concerning said purchaser is processed into e-mail, and said e-mail resulting from said processing is transmitted to said e-mail address.

12. The customer information collection method according to claim 1, wherein a password is assigned to said purchaser when said information data concerning said purchaser is transmitted, and said added information recorded on said recording medium is supplied when said password is inputted.

13. The customer information collection method according to claim 1, wherein once said information data concerning said purchaser is transmitted, said added information recorded on said recording medium is disclosed even if said purchaser of said product inputs none of said information concerning said purchaser as data.

14. The customer information collection method according to claim 1, wherein said customer information consists of one or more predetermined items, a type and scope of said data that is inputted for each of said items is set in advance, and in cases where data that fails to fit said type or scope of said inputted data is inputted, it is judged that none of said customer information data has been inputted.

15. A customer information collection system in which data is transmitted and received between one or more customer information input processing devices and a customer information processing device that are connected to an electrical communications, and customer information is collected and processed, wherein
said customer information input processing devices are respectively comprises:
a data read-in means which reads in and sends added information data concerning a product, which is recorded on a medium that is attached to said product,
an input means which converts an inputted customer information into customer information data and sends such data,
a data processing means which processes said customer information data supplied from said input means and transmits said data to said customer information processing device via said electrical communications circuit, said data processing means further reading said added information data into said data read-in means and processes said supplied added information data when said customer information data is inputted, and
an information display means which discloses added information based upon said added information data;
said customer information processing device comprises:
a receiving means which receives said customer information data transmitted via said electrical communications circuit,
an accumulating means which accumulates said customer information data, and
a database control means which constructs a database based on said customer information data, processes said customer information data so as to accumulate said data in said accumulating means, and controls a resulting database, and
a data tabulating and analyzing means which tabulates and analyzes said customer information data that is controlled by said database control means.

16. A recording medium recorded with:
a program which causes a computer to urge a purchaser of a product to input information concerning said purchaser, to transmit data consisting of information concerning said purchaser to a predetermined location via an electrical communications circuit when said information concerning said purchaser is inputted as data, and to provide added information concerning said product, and
said added information.
